(19) United States
(12) Patent Application Publication
(10) Pub. No.: US 2008/0001513 A1
(43) Pub. Date: Jan. 3, 2008

(54) Field emission microelectronic device

(75) Inventors: Pi-Jin Chen, Beijing (CN); Zhao-Fu Hu, Beijing (CN); Liang Liu, Beijing (CN); Shou-Shan Fan, Beijing (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: Tsinghua University, Beijing City (CN); HON HAI Precision Industry CO., LTD., Tu-Cheng City (TW)

(21) Appl. No.: 11/640,035

(22) Filed: Dec. 14, 2006

(30) Foreign Application Priority Data
Jun. 30, 2006 (CN) 200610061417.4

(51) Int. Cl. H01J 1/02

(52) U.S. Cl. 313/309

(57) ABSTRACT

A nano-scaled field emission electronic device includes a substrate, a cathode electrode, and an anode electrode. The cathode electrode is placed on the substrate and has an emitter. The anode electrode is positioned opposite to and spaced from the cathode electrode. The nano-scaled field emission electronic device further has at least one kind of inert gas filled therein. The following condition is satisfied: h< λ̅ₑ, wherein h indicates a distance between a tip of the emitter and the anode electrode, and λ̅ₑ indicates an average free path of an electron in the inert gases. More advantageously, the following condition is satisfied:

$$h < \frac{\overline{{λ}_{e}}}{10} .$$

### RELATED APPLICATIONS

This application is related to commonly-assigned application entitled, “FIELD EMISSION MICROELECTRONIC DEVICE”, filed ______ (Atty. Docket No. US11438), the content of which is hereby incorporated by reference thereto.

### BACKGROUND

1. Field of the Invention

The invention relates generally to field emission microelectronic devices and, more particularly, to a nano-scaled field emission electronic device, which is operated in an inert gas environment.

2. Discussion of Related Art

The invention of computers is derived from vacuum tubes. The first computer in the world includes about 18,000 vacuum tubes. In 1947, transistors were invented by Bell laboratory. Due to the characteristic of a low energy consumption and cost, easy to be mini-sized and integrated, and suitability for mass production, transistors quickly replaced the vacuum tubes in most applied fields. This replacement made the invention of microprocessors and the mass use of computers possible. However, in some special applied fields, the vacuum tubes still have some superiorities that can not be replaced by the transistors. These superiorities can be extremely high frequency, wide dynamic range, anti-reverse breakdown, large power capability, high-temperature operation, and/or high radiation resistance.

Detailed, firstly, in an accelerated voltage of about 10 voltage, the movement velocity of electrons in the vacuum tubes is about 1.87×10⁸ cm/s, and in an electrical field of about 104 V/cm, the movement velocity of electrons in the transistors is about 1.5×10⁷ cm/s. The movement velocity of the electrons in the vacuum tubes is more than that in the transistors. Thus, as long as a distance between an anode and a cathode of the vacuum tube is small enough (e.g., about 100 nanometers ), the vacuum tube can be made into one device having a switching velocity much quicker than that of the transistors. Secondly, the performance of the transistors is mainly affected by the operating temperature thereof, thereby generally limiting the operating temperature to below 350° C. However, the performance of the vacuum tubes is, relatively, insensitive to the operating temperature thereof, allowing the vacuum tube to be stably operated at a relatively high temperature. Thirdly, the performance of the transistors is greatly affected by the radiation of high-energy particles, with the performance of the transistors being unstable and even potentially damaged under a relatively large radiation intensity. However, the performance of the vacuum tubes is basically insensitive to the radiation of high-energy particles, thereby permitting vacuum tube to be operated under a fairly sizable radiation intensity. The above-described superiorities make the vacuum tubes have an irreplaceable value in real-time monitoring at high temperature situations and in fields of super-high velocity communication and signal processing, such as space investigation, geological exploration, reactor inspection, steel-making, jet engines, and so on.

However, conventional vacuum tubes generally have relatively large bulk and weight and thereby difficult to integrate. Thus, the conventional vacuum tubes cannot meet with the need of relatively complicated signal processing. In order to solve the shortcomings of the conventional vacuum tubes, micro vacuum tubes have been studied from the 1960's and micro triodes have been manufactured. The operating principle of the micro vacuum tubes is similar to that of the conventional vacuum tubes, and a high vacuum degree of an inner portion of the tubes is a virtual necessity. The reason is as follows: if the residual gases therein are ionized, they would damage the performance of the tubes. Detailedly, the positive ions would add noise in the tubes, and the excessive positive ions would collide with cathode electrodes therein, thereby potentially damaging the cathode electrodes. Furthermore, the residual gases adsorbed on surfaces of the cathode electrodes would possibly result the unstable performance of the tubes.

In general, the better the degree of the vacuum of the tubes is able to be kept in use, the better the performance thereof is. For the conventional vacuum tubes, the high vacuum degree of the inner portion thereof is kept by providing a getter in the inner portion thereof, in order to exhaust gases produced during the use process and/or residual gases during the sealing process. For the micro vacuum tubes, because the inner portion thereof is relatively small and the specific surface area thereof is relatively large, it is very difficult to keep the high vacuum degree in the inner portion thereof. This results in the micro vacuum tubes being difficult to be placed into practice.

What is needed, therefore, is a nano-scaled field emission electronic device which is operated in inert gases, the nano-scaled field emission electronic device having a superior performance and range of applications, and satisfactory vacuum maintenance.

### SUMMARY

In one embodiment, a nano-scaled field emission electronic device includes a substrate, a cathode electrode, and an anode electrode. The cathode electrode is placed on the substrate and has an emitter. The anode electrode is positioned opposite to and spaced from the cathode electrode. The nano-scaled field emission electronic device further has at least one kind of inert gases filled therein. The following condition is satisfied: h< λ̅ₑ , wherein h indicates a distance between a tip of the emitter and the anode electrode, and λ̅ₑ indicates an average free path of an electron in the inert gases.

Other advantages and novel features of the present nano-scaled field emission electronic device will become more apparent from the following detailed description of preferred embodiments when taken in conjunction with the accompanying drawings.

### BRIEF DESCRIPTION OF THE DRAWINGS

Many aspects of the present nano-scaled field emission electronic device can be better understood with reference to the following drawings. The components in the drawings are not necessarily to scale, the emphasis instead being placed upon clearly illustrating the principles of the present nano-scaled field emission electronic device.

FIG. 1 is a cross-sectional view of a nano-scaled field emission electronic device, in accordance with a first embodiment of the present device;

FIG. 2 is a cross-sectional view of a nano-scaled field emission electronic device, in accordance with a second embodiment of the present device; and

FIG. 3 is a cross-sectional view of a nano-scaled field emission electronic device, in accordance with a third embodiment of the present device.

Corresponding reference characters indicate corresponding parts throughout the several views. The exemplifications set out herein illustrate at least one preferred embodiment of the present nano-scaled field emission electronic device, in at least one form, and such exemplifications are not to be construed as limiting the scope of the invention in any manner.

### DETAILED DESCRIPTION OF PREFERRED EMBODIMENTS

Reference will now be made to the drawings to describe embodiments of the present nano-scaled field emission electronic device, in detail.

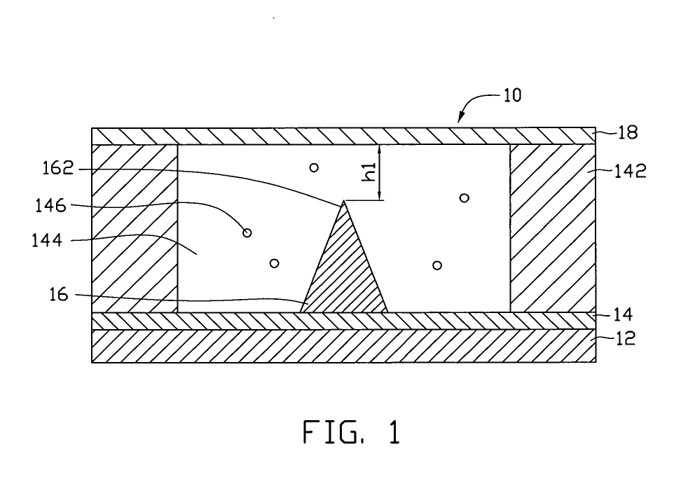

FIG. 1 shows a nano-scaled field emission electronic device 10, in accordance with a first embodiment of the present device. As shown in FIG. 1, the nano-scaled field emission electronic device 10 is bipolar and includes a substrate 12, a cathode electrode 14, an emitter 16, and an anode electrode 18. The cathode electrode 14 is positioned on the substrate 12. The emitter 16 is located on and is electrically connected with the cathode electrode 14. The emitter 16 has an emission tip 162, and the emission tip 162 faces the anode electrode 18. A distance between the emission tip 162 of the emitter 16 and the anode electrode 18 is labeled as h1 and is named as a feature size (i.e., an emission distance) of the nano-scaled field emission electronic device 10. The anode electrode 18 is positioned apart from the cathode electrode 14, and an insulating layer 142 is located therebetween. This arrangement forms a sealed space 144 between the cathode electrode 14 and the anode electrode 18.

A plurality of inert gas atoms 146, together referred to as an inert gas, is sealed in the sealed space 144. A pressure of the inert gas 146 sealed in the sealed space 144 is in the range from about 0.1 to about 10 atmospheric pressure (i.e., unit of atmospheres). Preferably, the pressure of the inert gas 146 is about one atmospheric pressure. The inert gas 146 can be selected from the group consisting of helium (He), neon (Ne), argon (Ar), krypton (Kr), xenon (Xe), and a mixture of such gases thereof. Preferably, the inert gas 146 is helium. Furthermore, the following condition is satisfied: h1< λ̅ₑ, wherein h1 indicates the feature size (i.e., the emission distance) of the nano-scaled field emission electronic device 10, and λ̅ₑ indicates an average free path of an electron in the inert gas atoms 146.

From the above description, the nano-scaled field emission electronic device 10 operates in the presence of the inert gas 146 and the feature size h1 thereof is relatively small. As such, the nano-scaled field emission electronic device 10 has the following advantages. Firstly, the relatively small feature size h1 ensures that probability of collision of electrons emitted by the emitter 16 with the inert gas atoms 146 is relatively small, when the electrons move to the anode electrode 18. When the feature size h1 of the electron in the inert gas 146 is far smaller than the average free path λ̅ₑ of the electron in the inert gas 146, the electrons will rarely collide with the inert gas atoms 146. At this state, it can be considered that the electrons can get to the anode electrode 18 essentially freely. Preferably, as such, the feature size h1 is smaller than one tenth of the average free path λ̅ₑ of the electron in the inert gas 146

$$( i . e . , h < \frac{\overline{{λ}_{e}}}{10} ) .$$

Detailedly, the average free path λ̅ₑ of the electron in the inert gases can be expressed as follows:

$$\overline{{λ}_{e}} = \frac{4}{π n {σ}^{2}} = \frac{4 kT}{{πσ}^{2} p} ,$$

wherein n indicates a density of the inert gases; σ indicates an effective diameter of molecules of the inert gases; k indicates the Boltzmann constant, and the value thereof is equal to 1.38×10⁻²³ J/K; T indicates an absolute temperature of the inert gas; and p indicates a pressure of the inert gas. Detailedly, at one atmospheric pressure, and when the absolute temperature T of the inert gas is equal to 300 K, the average free paths of the electron in different kinds of inert gases is expressed in the following Table 1:

TABLE 1

| | inert gas | | | | |
|---|---|---|---|---|---|
| | He | Ne | Ar | Kr | Xe |
| σ (10⁻¹⁰ m) | 2.18 | 2.6 | 3.7 | 4.2 | 4.9 |
| λ̅_{e (μm)} | 1.07 | 0.77 | 0.38 | 0.29 | 0.22 |

In the preferred embodiment, the inert gas 146 is helium. When the nano-scaled field emission electronic device 10 includes helium gas 146 at one atmospheric pressure, as long as the feature size h1 is far smaller than the average free path λ̅ₑ (i.e., 1.07 μm) of the electron in the helium gas 146, the electrons nearly don't (i.e., rarely) collide with the helium gas atoms 146 and can likely get to the anode electrode 18 freely. Furthermore, as shown in the following Table 2, when the feature size h1 is smaller than one tenth of the average free path λ̅ₑ of the electron in the helium gas 146 (i.e., 107 nm), 91 percent of the electrons emitted by the emitter 16 don't collide with the atoms of the helium gases 146 and can get to the anode electrode 18 freely.

TABLE 2

| | feature size | | | | |
|---|---|---|---|---|---|
| | 0.01 λ̅ₑ | 0.1 λ̅ₑ | 1 λ̅ₑ | 5 λ̅ₑ | 10 λ̅ₑ |
| probability of free moving | 0.99 | 0.91 | 0.37 | 0.007 | 4.5 × 10⁻⁵ |

Secondly, because the feature size h1 of the nano-scaled field emission electronic device 10 is smaller than the average free path λ̅ₑ of the electron in the helium gas 146, that is, the distance between the emission tip 162 of the emitter 16 and the anode electrode 18 is relatively small, an emission voltage needed by the nano-scaled field emission electronic device 10 to emit electrons is also relatively small. Thus, an amount of energy obtained by the electrons from the emission voltage is relatively low. When the obtained energy of the electrons is smaller than the first ionization energy of the inert gas 146, the atoms of the inert gas 146 would not be ionized by an electron of such an energy. When the obtained energy of the electrons is equal to or only a little greater than the first ionization energy of the inert gases 146, the ionization ratio of the atoms of the inert gas 146 is relatively low or even can be ignored. Table 3 shows the first ionization energy of different kinds of inert gases. Thus, in the preferred embodiment, even if the electrons emitted by the emitter 16 would collide with the atoms of the inert gas 146, the atoms of the inert gas 146 would, most likely, not be ionized.

TABLE 3

| | inert gas | | | | |
|---|---|---|---|---|---|
| | He | Ne | Ar | Kr | Xe |
| first ionization energy | 24.587 | 21.564 | 15.759 | 13.999 | 12.130 |
| (eV) | | | | | |

Thirdly, because the nano-scaled field emission electronic device 10 includes the inert gas 146, the atoms of inert gas 146 not only would not be adsorbed on a surface of the emitter 16 (i.e., due to the inert nature thereof), but such atoms also can continue to bombard the emitter 16 due to the kinetic energy thereof. This bombardment can remove molecules of impurity gases adsorbed on the emitter 16 during the manufacturing process and so on. This removing can clean the emitter in a certain extent and can help the nano-scaled field emission electronic device 10 to run/operate stably.

Detailedly, the bombardment frequency of the molecules of the gases on a per unit area of the device can be expressed as follows:

$$υ = \frac{1}{4} n \overline{υ} = \frac{p}{\sqrt{2 π {m}_{0} kT}} = \frac{p \cdot {N}_{A}}{\sqrt{2 π MRT}} ,$$

wherein n indicates a density of the molecules of the gas; υ̅ indicates an average speed produced by the kinetic energy of the molecules/atoms of the gas; p indicates a pressure of the gas; M indicates an atomic weight of the gas; N_{A} indicates Avogadro constant, and the value thereof is equal to 6.02×10⁻²³ mol; T indicates an absolute temperature of the gases; and R is equal to 8.31 J/(mol.K).

In the preferred embodiment, the nano-scaled field emission electronic device 10 is at work at a temperature of about 300 K and includes helium gas 146 of one atmospheric pressure. In this situation, the bombardment frequency of the molecules of the helium gas 146 on a per unit area of the emitter 16 of the nano-scaled field emission electronic device 10 is about 7.7×10²⁷/m²s. Considering the emitter tip 146 of the emitter 16 as a hemisphere having a radius of about one nanometer, the bombardment frequency of the atoms of the helium gas 146 on the emitter tip 146 of the emitter 16 is about 4.8×10¹⁰/s. An area of one molecule of the impurity gases, such as water vapor adsorbed on the emitter 16, is about 10⁻¹⁹m², and, thus, the bombardment frequency to the water vapor is about 7.7×10⁸/s. The above-described bombardment frequency is relatively high, thereby having a strong cleaning effect. This strong cleaning effect can keep the emitter 16 from being adsorbed by the atoms of the impurity gases and ensure the good field emission performance of the emitter 16.

The anode electrode 18 is advantageously made of a high-temperature, oxidation-resistant metal material selected from the group consisting of gold (Au), platinum (Pt), silver (Ag), titanium (Ti), copper (Cu), aluminum (Al), tungsten (W), molybdenum (Mo), tantalum (Ta), rhenium (Re), niobium (Nb), nickel (Ni), chromium (Cr), zirconium (Zr), and/or hafnium (Hf). Alternatively, the anode electrode 18 could be made of a semiconductor material selected from the group consisting of silicon (Si), germanium (Ge), and gallium nitride (GaN). Still alternatively, the anode electrode 18 could be made of the above-mentioned semiconductor material with the above-mentioned metal material coated thereon. The cathode electrode 14 is beneficially made of the same material as that of the anode electrode 18.

The emitter 16 is a micro-tip structure, usefully made of the semiconductor material selected from the group consisting of silicon (Si), molybdenum (Mo), and tungsten (W). Furthermore, the emitter 16 has a film of a low work function material deposited thereon. The low work function material can be a metal boride, such as lanthanum hexaboride (LaB₆), and/or a rare earth oxide, such as lanthanum oxide (La₂O₃), yttrium oxide (Y₂O₃), gadolinium oxide (Gd₂O₃), and/or dysprosium oxide (Dy₂O₃). Alternatively, the emitter 16 can be made of the material sintered to include one or more materials chosen from the group of the above-mentioned rare earth oxides, carbides, and metals with a relatively high melting point. The carbides can be thorium carbide, zirconium carbide, titanium carbide, tantalum carbide, and so on. The metals with the relatively high melting point can be, e.g., tungsten (W), molybdenum (Mo), niobium (Nb), rhenium (Re), platinum (Pt), and so on. Still alternatively, the emitter 16 can, further advantageously, have a carbon nanotube or a semiconductor nanowire attached on one of the above-described micro-tip structures. It is understood that the carbon nanotube or the semiconductor nanowire could instead be directly formed on the cathode electrode 14 to act as the emitter 16.

In use, a field emission voltage is provided between the cathode electrode 14 and the anode electrode 18, and the surface-barrier of the tip 162 of the emitter 16 is decreased and narrowed in the effect of the electric field formed by the field emission voltage. When the surface-barrier of the tip 162 is narrowed to a thickness similar to the wavelength of the electrons, the electrons penetrate the surface-barrier of the tips 162 of the emitter 16, due to the tunneling effect, and enter the sealed space 144. By this process, the emission of the electrons is thereby achieved.

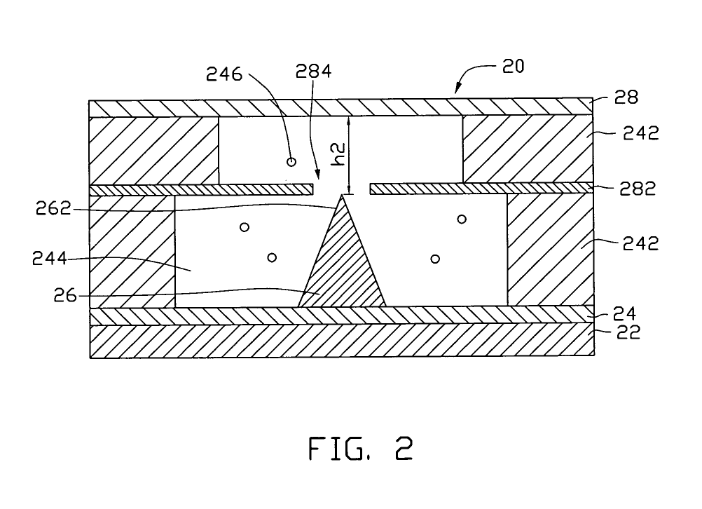

Referring to FIG. 2, a nano-scaled field emission electronic device 20, in accordance with a second embodiment of the present device, is shown. The nano-scaled field emission electronic device 20 is a triode and includes a substrate 22, a cathode electrode 24, an emitter 26, an anode electrode 28, and a gate electrode 282. The cathode electrode 24 is positioned on the substrate 22. The emitter 26 is located on and electrically connected with the cathode electrode 24. The emitter 26 has an emission tip 262, and the emission tip 262 faces the anode electrode 28. The anode electrode 28 is positioned apart (i.e., spaced) from the cathode electrode 24, and the gate electrode 282 is located between the anode electrode 28 and the cathode electrode 24. An insulating layer 242 is located between the anode electrode 28 and the gate electrode 282 and between the gate electrode 282 and the cathode electrode 24. This arrangement forms a sealed space 244 between the cathode electrode 24 and the anode electrode 28. A plurality of inert gas atoms 246, collectively considered to establish an inert gas 246, is sealed in the sealed space 244. The gate electrode 282 has an opening 284 corresponding to the emitter 26. Furthermore, a distance h2 between the emission tip 262 of the emitter 26 and the anode electrode 28 (i.e., a feature size or emission distance of the nano-scaled field emission electronic device 20) is smaller than an average free path of an electron in the inert gas 246.

The nano-scaled field emission electronic device 20 is similar to the nano-scaled field emission electronic device 10, except that the nano-scaled field emission electronic device 20 is a triode and further includes the gate electrode 282. The material of the substrate 22, cathode electrode 24, emitter 26, and anode electrode 28 in the second embodiment is as same as that of the substrate 12, cathode 14, emitter 16, and anode electrode 18 in the first embodiment, respectively. The material of the gate electrode 282 is as same as that of the anode electrode 28. The potential gases for the inert gas 246 in the second embodiment are the same as those for the inert gas 146 in the first embodiment. In use, a controlling voltage is provided on/across the gate electrode 282 to control the emitter 26 to selectably emit electrons. Furthermore, a voltage is provided on/across the anode electrode 28 to ensure the electrons quickly reach the anode electrode 28.

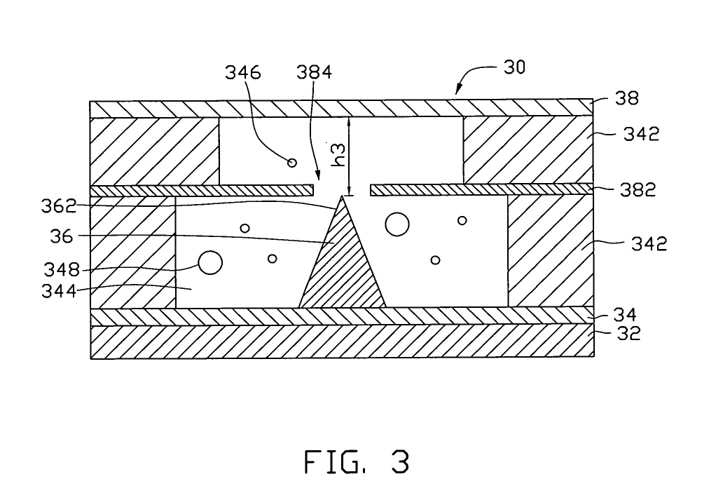

Referring to FIG. 3, a nano-scaled field emission electronic device 30, in accordance with a third embodiment of the present device, is shown. The nano-scaled field emission electronic device 30 is a triode and includes a substrate 32, a cathode electrode 34, an emitter 36, an anode electrode 38, and a gate electrode 382. The cathode electrode 34 is positioned on the substrate 32. The emitter 36 is located on and is electrically connected with the cathode electrode 34. The emitter 36 has an emission tip 362, and the emission tip 362 faces the anode electrode 38. The anode electrode 38 is positioned apart from the cathode electrode 34, and the gate electrode 382 is located between the anode electrode 38 and the cathode electrode 34. An insulating layer 342 is located between the anode electrode 38 and the gate electrode 382 and between the gate electrode 382 and the cathode electrode 34. This arrangement forms a sealed space 344 between the cathode electrode 34 and the anode electrode 38. A plurality of inert gas atoms 346, 348 is sealed in the sealed space 344. The gate electrode 382 has an opening 384 corresponding to the emitter 36. Furthermore, a distance h3 between the emission tip 362 of the emitter 36 and the anode electrode 38 (i.e., a feature size or emission distance of the nano-scaled field emission electronic device 30) is smaller than an average free path of an electron in the inert gases 346, 348.

The nano-scaled field emission electronic device 30 is similar to the nano-scaled field emission electronic device 20, except that at least two different kinds of inert gases 346, 348 are sealed in the sealed space 344. In the third embodiment, for illustration purposes, the inert gas 346 is helium (He), and the inert gas 348 is neon (Ne). The helium gas 346 can enhance the average free path of the electrons in the sealed space 344, and this enhanced average free path reduces the requirement to the feature size h3 of the nano-scaled field emission electronic device 30, allowing for a larger emission distance h3 to be chosen, if desired. Furthermore, the atomic weight of the neon gas 348 is relatively large, and this atomic size ensures that the neon gas 348 has a better ability to clean the surface of the emitter 36 and remove impurity gases absorbed on the emitter 36.

It can be understood that the nano-scaled field emission electronic device 10, in accordance with the first embodiment, can also has at least two different kinds of inert gases sealed therein. The inert gas with a relatively large atomic weight has a better ability for cleaning the surface of the emitter 16 and removing impurity gases absorbed on the emitter 16, and the inert gas with a relatively small atomic weight can enhance the average free path of the electrons in the sealed space 144, thereby reducing the requirement to the feature size h1 (i.e., actually allowing a potential increase in the size thereof) of the nano-scaled field emission electronic device 10.

It can be further understood that the nano-scaled field emission electronic devices in accordance with the embodiments can be manufactured by means of e-beam lithography cooperating with dry etching, wet etching, and/or vacuum coating. The encapsulation of the nano-scaled field emission electronic devices can be executed by evacuating the devices and then filling the inert gas(es) in the devices. Alternatively, the nano-scaled field emission electronic devices can be encapsulated in the presence of the flowing inert gas(es). This encapsulation process does not need the step of evacuation, thereby enhancing the manufacture efficiency and reducing the manufacture cost. Furthermore, the bipolar nano-scaled field emission electronic devices 10 and the triode nano-scaled field emission electronic devices 20, 30 can be integrated on one substrate. This integration forms an integrated circuit that can achieve the management and operation of the relatively complex signals.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

We claim:

1. A nano-scaled field emission electronic device comprising:
a substrate;
a cathode electrode placed on the substrate and carrying an emitter thereon, the emitter having a tip;
an anode electrode positioned opposite to and spaced from the cathode electrode; and
at least one inert gas material provided between the cathode and the anode, the at least one inert gas material collectively establishing an inert gas, the following condition being satisfied: h< λ̅ₑ, wherein h indicates a distance between the tip of the emitter and the anode electrode, and λ̅ₑ indicates an average free path of electrons in the inert gas.

2. The nano-scaled field emission electronic device as claimed in claim 1, further comprising a grid electrode positioned between the cathode electrode and the anode electrode.

3. The nano-scaled field emission electronic device as claimed in claim 2, wherein the grid electrode includes an opening corresponding to the emitter of the cathode electrode.

4. The nano-scaled field emission electronic device as claimed in claim 1, wherein the emitter comprises a micro-tip structure.

5. The nano-scaled field emission electronic device as claimed in claim 4, wherein the emitter is comprised of a material selected from a group consisting of silicon, molybdenum, and tungsten.

6. The nano-scaled field emission electronic device as claimed in claim 5, wherein the emitter has a film coated thereon, the film being comprised of a material with a lower work function than that of the emitter.

7. The nano-scaled field emission electronic device as claimed in claim 4, wherein the emitter is comprised of at least one material selected from a group consisting of rare-earth oxides; carbides; and metals with relatively high melting points.

8. The nano-scaled field emission electronic device as claimed in claim 4, wherein the emitter has at least one carbon nanotube or semiconductor nanowire assembled thereon.

9. The nano-scaled field emission electronic device as claimed in claim 1, wherein the emitter is selected from a group consisting of a carbon nanotube, a semiconductor nanowire, and an array thereof.

10. The nano-scaled field emission electronic device as claimed in claim 1, wherein a pressure of the at least one inert gas material is in the approximate range from 0.1 to 1 atmosphere pressure.

11. The nano-scaled field emission electronic device as claimed in claim 1, wherein the at least inert gas material is selected from a group consisting of helium (He), neon (Ne), argon (Ar), krypton (Kr), xenon (Xe), and a mixture thereof.

12. The nano-scaled field emission electronic device as claimed in claim 1, wherein the following condition is further satisfied:
$$h < \frac{\overline{{λ}_{e}}}{10} ,$$
wherein h indicates the distance between the tip of the emitter and the anode electrode, and λ̅ₑ indicates the average free path of the electrons in the inert gas.

13. The nano-scaled field emission electronic device as claimed in claim 1, wherein the average free path λ̅ₑ of the electron in the inert gases can be expressed as follows:
$$\overline{{λ}_{e}} = \frac{4}{π n {σ}^{2}} = \frac{4 kT}{{πσ}^{2} p} ,$$
wherein n indicates a density of the inert gases; σ indicates an effective diameter of molecules of the inert gases; k indicates the Boltzmann constant, and the value thereof is equal to 1.38×10⁻²³ J/K; T indicates an absolute temperature of the inert gas; and p indicates a pressure of the inert gas.

14. The nano-scaled field emission electronic device as claimed in claim 1, wherein an emission voltage between the cathode and the anode is a voltage required to achieve emission of electrons from the emitter, the distance h permitting that an amount of energy obtained by the electrons from the emission voltage is able to be less than or equal to about a first ionization energy of each inert gas material.

15. The nano-scaled field emission electronic device as claimed in claim 1, wherein the at least one inert gas material has a kinetic energy associated therewith, the at least one inert gas material thereby being able to bombard the emitter and potentially remove molecules of impurity gases adsorbed on the emitter.
